(19) United States
(12) Patent Application Publication
(10) Pub. No.: US 2010/0110264 A1
(43) Pub. Date: May 6, 2010

(54) Image projection system

(75) Inventor: Martin D. Carroll, Watchung, NJ (US)

Correspondence Address: Jay M. Brown, 6409 Fayetteville Road, Suite 120-306, Durham, NC, 27713, US

(73) Assignee: Lucent Technologies, Inc., Murray Hill, NJ (US)

(21) Appl. No.: 12/290,620

(22) Filed: Oct. 31, 2008

(51) Int. Cl. H04N 5/222; H04N 9/31

(52) U.S. Cl. 348/333.01; 348/744; 348/E05.022; 348/E09.025

(57) ABSTRACT

System including image projector and video camera. System further includes signal processor configured to be in communication with image projector and video camera, and with a video monitor. Image projector is configured for receiving and projecting first image onto surface of an object. Video camera is configured for capturing second image including first image as projected onto object. System is configured for transmitting second image for display by video monitor. Method that includes providing image projector and video camera. Method further includes providing signal processor configured to be in communication with image projector, video camera, and a video monitor. Method also includes causing image projector to receive and to project first image onto surface of an object, causing video camera to capture second image including first image as projected onto object, and causing system to transmit second image for display by video monitor.

### BACKGROUND OF THE INVENTION

1. Field of the Invention

This invention generally relates to systems and methods for capturing and displaying images.

2. Related Art

This section introduces aspects that may help facilitate a better understanding of the invention. Accordingly, the statements of this section are to be read in this light and are not to be understood as admissions about what is prior art or what is not prior art.

Various types of systems exist for capturing and displaying images. Systems are available that facilitate the transmission of an image from one location for display at another location. Systems are also available that are capable of capturing a manually-defined image. Despite these developments, there is a continuing need for improved systems for capturing and displaying images.

### SUMMARY

In an example of an implementation, a system is provided, including an image projector and a video camera. The system further includes a signal processor configured to be in communication with the image projector, with the video camera, and with a video monitor. The image projector is configured for receiving and projecting a first image onto a surface of an object. The video camera is configured for capturing a second image including the first image as projected onto the object. The system is configured for transmitting the second image for display by the video monitor.

As another example of an implementation, a method is provided, that includes providing an image projector and a video camera. The method further includes providing a signal processor configured to be in communication with the image projector, with the video camera, and with a video monitor. In addition, the method includes causing the image projector to receive and to project a first image onto a surface of an object, and causing the video camera to capture a second image including the first image as projected onto the object, and causing the system to transmit the second image for display by the video monitor.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a schematic view showing an example of an implementation of a system.

FIG. 2 is a flow chart showing an example of an implementation of a method.

### DETAILED DESCRIPTION

Collaboration among experts as well as between experts and non-experts occurs in many venues. Often, these experts and non-experts may be at separate locations at the time of their collaboration. In some cases, one person may be located at a site where a collaborative task needs to be carried out, while another person may be located off-site and perhaps quite far away from that site. An expert or non-expert may be located at either or both of the collaborative site and an off-site location, depending on the circumstances. A non-expert may be involved, as examples, as a customer for a requested task, or as a non-expert decision-maker, or in an emergency may be designated to carry out a task on-site despite lacking expertise and under the off-site direction of an expert. In many real-life situations illustrating these types of collaborations, problems may arise in attempted communication of an off-site expert's or an off-site non-expert's input to an on-site person regarding the collaborative task to be carried out. For example, that input may optimally take the form of a drawing to be utilized on-site as guidance for carrying out a task. As further examples, the off-site input may include guidance in performing a cutting operation or an operation involving ablation of a surface. Also, for example, where a task is to be carried out on a three-dimensional object, communication from an off-site location of instructions for the task, such as by a drawing, may present the added challenge of properly carrying out the drawn instructions for the task on the three-dimensional object. Feedback from the off-site person as to mapping of the drawing onto the three-dimensional object, for example, might then be helpful.

For example, a surgeon may be located in an operating room together with a patient on which the surgeon is tasked to perform an operation. Further, for example, the operation may have been recommended by a pathologist, cardiologist or another medical specialist, who has the proper expertise for defining the surgical procedure to be done. As an example, specific tissues of the patient, such as a tumor or a part of an organ, may be designated for removal. As another example, a bypass operation on the patient's heart may be needed. The pathologist, cardiologist or other specialist may be located across town or thousands of miles away on a different continent, such that enhancing virtual participation by the pathologist, cardiologist or other specialist in real time with the surgeon during the operation might enhance the surgeon's performance. As another example, the pathologist, cardiologist or other specialist may be located in the operating room together with the surgeon and the surgery patient, such that more precise input from the pathologist, cardiologist or other specialist regarding the operation to be performed might enhance the surgeon's performance. Once a surgeon opens an incision in the patient's body, clear demarcation of boundaries for internal incisions or other surgical maneuvers might assist the surgeon. Further, for example, an expert regarding some other manipulation to be performed on or recommended to a person may be located off-site from someone else who will manipulate or lead the person, such as an expert regarding physical therapy, medical examination, non-invasive medical procedures, dance, gymnastics, exercise, or other activities. As additional examples, an expert or other person may be located off-site from an apparatus or another object needing to be subjected to construction, repairs, analysis, or other operations, such as a jet engine, an industrial machine or system, or a computer system. In a further example, one of several people located in the same room may wish to prepare or modify a drawing in real time for viewing by another person in the room. Systems and methods are provided herein that may be utilized in preparing images to enhance collaborations among experts as well as between experts and non-experts, as illustrated by the foregoing examples.

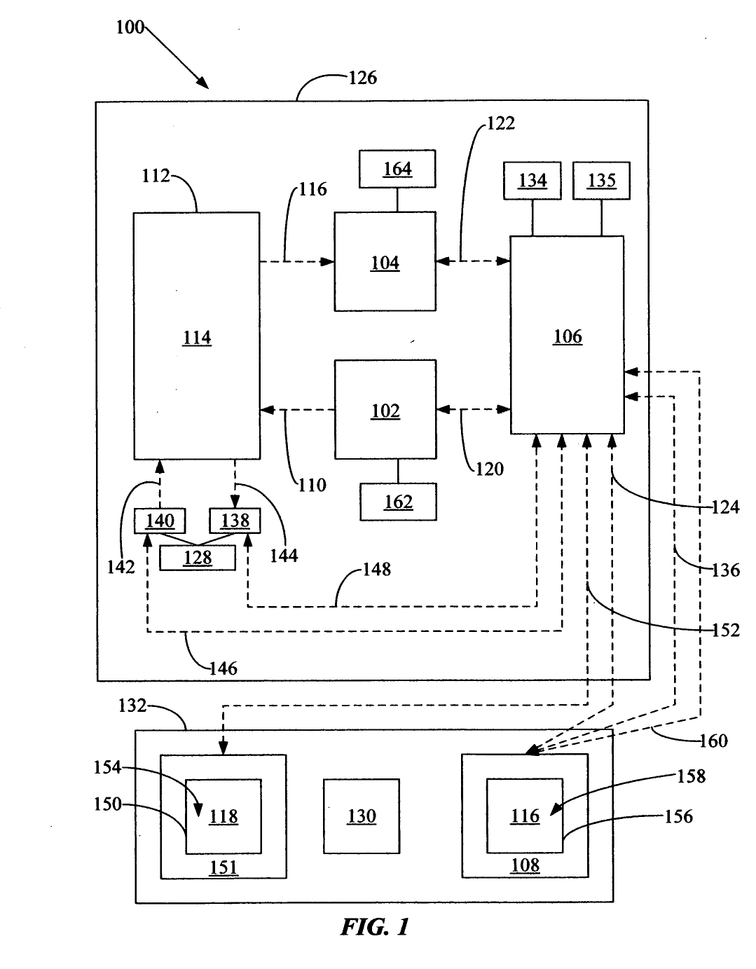

FIG. 1 is a schematic view showing an example of an implementation of a system 100. The system 100 includes an image projector 102 and a video camera 104. The system 100 further includes a signal processor 106 configured to be in communication with the image projector 102 and with the video camera 104. The signal processor 106 is also configured to be in communication with a video monitor 108. The image projector 102 is configured for receiving and projecting a first image represented by a dashed arrow 110 onto a surface 112 of an object 114. The video camera 104 is configured for capturing a second image represented by a dashed arrow 116. The second image 116 includes a version of the first image 110 as projected onto the surface 112 of the object 114. The system 100 is configured for transmitting the second image 116 for display by the video monitor 108.

In an example, the first image 110 may include a drawing 118. It is understood throughout this specification that the term “drawing” denotes a graphic representation, including one or more lines, of an object or idea. It is further understood throughout this specification that a “drawing” may, in addition to one or more lines, include other graphic representations. A “drawing” may be executed in black-and-white, grayscale, color, selected colors each having defined meanings, or another color scheme. A “drawing” may include solid, dashed, dotted, thin, heavy, and other types of lines. It is understood throughout this specification that the term “image” denotes a visible likeness or representation of a real or abstract thing, where examples of a real or abstract thing include an object, a person, an animal, a system, a process, and a thought.

The signal processor 106 may be in communication with the image projector 102 through a signal-bearing medium represented by a dashed arrow 120, and with the video camera 104 through a signal-bearing medium represented by a dashed arrow 122. The signal processor 106 may further be in communication with the video monitor 108 through a signal-bearing medium represented by a dashed arrow 124. The signal-bearing media in the system 100, such as the signal-bearing media 120, 122, 124, may each independently include, as examples (not shown), an electrical conductor, an optical conductor, a wireless electromagnetic radiation link such as a microwave or radio link, or a combination including two or more of the foregoing.

In an example of operation of a system 100, the object 114 may be a surgical patient 114 located in a hospital operating room 126. A surgeon or other person 128 may also be located in the hospital operating room 126, preparing to carry out an operation on the surgical patient 114. A pathologist or other person 130 may, for example, be located in another room or other location 132 equipped with a video monitor 108. As examples, the room 132 may be located in the same hospital or other medical facility where the operating room 126 is located, or may be across town, or may be thousands of miles away on a different continent. The image projector 102 and the video camera 104 may be in communication with the operating room 126. The signal processor 106 may be located in the operating room 126 as shown in FIG. 1, or may be in communication with the operating room 126 but located elsewhere. The image projector 102 may be caused to receive and project a first image 110 onto a surface 112, where that surface 112 in this example may be a portion of the skin or of the exposed internal tissues of the surgical patient 114. For example, the system 100 may be configured to facilitate an input by the pathologist 130 of a drawing 118 intended by the pathologist 130 to be included in the first image 110. The signal processor 106, for example, may utilize the drawing 118 in generating the first image 110 as a representation of the drawing 118.

Further in this example of operation, the video camera 104 is configured for capturing a second image 116 that includes a version of the first image 110 as projected onto the portion of the skin or of the exposed internal tissues 112 of the surgical patient 114. In this example, the system 100 is configured for transmitting the second image 116 for display by the video monitor 108. The system 100 may be further configured, for example, to facilitate an input by the pathologist 130 of additions, deletions, and other changes in the drawing 118, based on viewing by the pathologist 130 of the second image 116 as displayed by the video monitor 108. In this manner, for example, the pathologist 130 may effectively make changes in the version of the first image 110 as projected onto the portion of the skin or exposed internal tissues 112 of the surgical patient 114. In this regard, for example, the system 100 may enable the pathologist 130 to observe the second image 116 and to then make changes in the drawing 118 as represented in the version of the first image 110 as projected onto the portion of the skin or exposed internal tissues 112 of the surgical patient 114. The pathologist 130 may make these changes, for example, despite being currently located in the room 132 which may be at a distance far away from the surgeon 128 contemporaneously located in the hospital operating room 126 with the surgical patient 114. Further, for example, these changes in the drawing 118 may be made in real-time in multiple successive iterations of changes in the drawing 118 or creation and projection of new drawings 118, while the surgeon or other person 128 carries out an operation on the surgical patient 114. After the surgeon 128 exposes internal tissue surfaces 112 of the surgical patient 114, for example, a pathologist 130 may observe the second image 116 and create a new or modified drawing 118 for projection in the first image 110 onto internal tissue surfaces 112 of the surgical patient 114. Hence, the system 100 may, for example, enable the pathologist 130 to effectively create a drawing 118 on the soft internal tissue surfaces 112 of the surgical patient 114.

Furthermore, the drawing 118 may be projected in the first image 110 onto the surgical patient 114 by the system 100, as an example, without any potential compromise of a sterile operating procedure being caused by the system 100. The system 100 may effectively facilitate projection of stable, sterile, erasable drawings 118 in the first image 110 onto skin, soft tissue, or hard tissue of the surgical patient 114, as examples. As another example, the pathologist 130 may effectively make changes in the version of the first image 110 as projected onto the portion of the skin or exposed internal tissues 112 of the surgical patient 114, without having to comply with sterile operating room procedures. The pathologist 130, for example, may be located in a non-sterile room 132 separated from the sterile operating room 126 by a large window, while revising the drawing 118. In a further example, the pathologist 130 may be located in the operating room 126 together with the surgeon 128. As an additional example, the person 130 may be the same person as the person 128. As an example, a surgeon 128 may utilize the system 100 to himself create a drawing 118 for projection in the first image 110 onto a surface 112 of the surgical patient 114. In another example, the operating room 126 may be a field location during a military or police exercise involving a surgical patient 114, and the person 130 may be a surgeon or other medical specialist at another location 132 providing advice, instructions or other information to a person 128 such as a surgeon, to assist the person 128 in carrying out surgery or another procedure on the surgical patient 114.

In an example, the system 100 may be configured for generating a digitally encoded representation of the first image 110 and a digitally encoded representation of the second image 116. Further in that example, the system 100 may be configured for transmitting the digitally encoded representation of the first image 110 to the image projector 102 and for transmitting the digitally encoded representation of the second image 116 to the video monitor 108. The digitally encoded representations may, as an example, include image formatting and other image control data as well as image data. As an example, the signal processor 106 may transmit the digitally encoded representation of the first image 110 through the signal-bearing medium 120 to the image projector 102, may receive the digitally encoded representation of the second image 116 from the video camera 104 through the signal-bearing medium 122, and may transmit the digitally encoded representation of the second image 116 through the signal-bearing medium 124 to the video monitor 108. As an example, signal-bearing media 120, 122, 124 may be dedicated to the system 100, or may utilize an external telecommunications network such as the Internet or a telephone network for parts or all of the transmissions. Such a network may include suitable network equipment, such as switches and routers as examples.

In another example, the signal processor 106 may include or be in communication with a digital video encoder 134 configured for carrying out digital encoding of the first and second images 110, 116. Further, for example, the signal processor 106 may include or be in communication with a digital video decoder 135 configured for carrying out digital decoding of the first and second images 110, 116. In a further example (not shown) the image projector 102 may include or be in communication with a digital video decoder (not shown) configured for decoding and facilitating projection of the first image 110 by the image projector 102. Also for example (not shown) the video camera 104 may include or be in communication with a digital video encoder (not shown) configured for encoding the second image 116 for transmission through the system 100. As an additional example (not shown) the video monitor 108 may include or be in communication with a digital video decoder (not shown) configured for decoding and facilitating display of the second image 116.

As an example (not shown) the video monitor 108 may be configured for displaying two or all among the first and second images 110, 116 and the drawing 118. In an example, the video monitor 108 may be configured to receive an input of the first image 110 from the signal processor 106 through a signal-bearing medium represented by a dashed arrow 136. Further, as examples (not shown), the video monitor 108 may be configured to display two or all among the first and second images 110, 116 and the drawing 118 simultaneously or sequentially, such as side-by-side or as superimposed on each other, and where each of the first and second images 110, 116 and the drawing 118 may have differentiated colors, patterns, labels, or other distinguishing characteristics.

In an example, the surface 112 of the object 114 may be a three-dimensional surface 112. In that case, projection of the first image 110 by the image projector 102 onto the three-dimensional surface 112 of the object 114 may result in distortions of the first image 110. As a result, the second image 116 as captured by the video camera 104 may include a distorted version of the first image 110 superimposed on an image of the three-dimensional surface 112. For example, the first image 110 may include a representation of a drawing 118 created by a pathologist 130 collaborating with a surgeon 128 who will carry out a surgical operation on a patient 114. In that example, the first image 110 including a representation of the drawing 118 created by the pathologist 130 may subsequently be distorted by being projected by the image projector 102 onto the three-dimensional surface 112 of the surgical patient 114. Further in that example, that distortion of the first image 110 may degrade the intended utility of the expertise of the pathologist 130 represented by the drawing 118 in the undistorted first image 110 intended to guide the surgeon 128 in carrying out a surgical operation on the patient 114. Accordingly, for example, the system 100 may be configured for determining a difference between the drawing 118 and the second image 116. Further, in that example, the system 100 may be configured for modifying the first image 110 to reduce that difference. For example, the system 100 may be configured for generating a random modification of the first image 110, then re-determining the difference between the drawing 118 and the second image 116, saving the first image 110 if the difference is reduced, and generating another such random modification unless the difference has become less than a selected threshold.

As another example, the signal processor 106 may be configured for computing a three-dimensional contour of a surface 112 of the object 114 and for correcting the first image 110 to be projected by the image projector 102, in conformance with the contour. Display by the system 100 of the accordingly-corrected first images 110 may, for example, have the function of causing the first image 110 to appear to be fixed in position on the object 114.

As an example, the system 100 may be configured to project a patterned first image 110 onto the object 114, and to then compute a difference between the patterned first image 110 and a resulting second image 116. In an example, the image projector 102 may be configured for projecting such a patterned first image 110, such as a rectangular grid (not shown) onto the object 114. The system 100 may, for example, further be configured to utilize that difference for computing a three-dimensional contour of a surface 112 of the object 114 and for correcting the first image 110 to be projected by the image projector 102, in conformance with the contour. For example, the object 114 may be a surgical patient 114, and the signal processor 106 may be configured for computing a three-dimensional contour of a portion of the skin or exposed internal tissues 112 of the surgical patient 114. Further, the signal processor 106 may be configured for then computing corrections to the first image 110 in conformance with the contour. For example, the video camera 104 may be configured for capturing an image of the surface 112 of the object 114, and the signal processor 106 may be configured to utilize that image of the surface 112 for then computing a three-dimensional contour of the surface 112 of the object 114. Further, for example, the signal processor 106 may be configured to then utilize that three-dimensional contour for correcting the first image 110 in conformance with the contour. The system 100 may be configured, as another example, to utilize the first image 110 and the image of the surface 112 of the object 114, in computing a three-dimensional contour of the object 114 and for correcting the first image 110 in conformance with the contour. Further, for example, the system 100 may be configured to also determine a difference between the drawing 118 and the second image 116, and to then reduce that difference by modifying the first image 110.

As an alternative to configuring the system 100 to project a patterned first image 110 onto the object 114 for then computing a difference between the patterned first image 110 and a resulting second image 116, that difference to be further utilized as discussed above, the system 100 may for example instead be configured to include a second video camera (not shown) in addition to the video camera 104 for computing such a difference. In that example, the two video cameras may be positioned at two different angles relative to the object 114 for each capturing a second image 116. In that example, the second image 116 captured by the video camera 104 may be compared with the second image (not shown) captured by the second video camera (not shown), and differences between the second images 116 may be analyzed for computing a three-dimensional contour of the surface 112 of the object 114.

As an example, the system 100 may include a video camera 138 configured for being carried or worn by a surgeon or other person 128. Further, for example, the system 100 may include an image projector 140 configured for being carried or worn by the person 128. As examples, the video camera 138 and the image projector 140 may be incorporated into or configured for attachment to eyeglasses or another wearable head-piece (not shown). The signal processor 106 may, for example, be configured to be in communication with the video camera 138 and with the image projector 140. The image projector 140 may be configured, as an example, for projecting a first image represented by a dashed arrow 142 onto the surface 112 of the object 114. The video camera 138 may be configured, in another example, for capturing a second image represented by a dashed arrow 144. In examples, the image projector 140 may be in communication with the signal processor 106 through a signal-bearing medium represented by a dashed arrow 146, and the video camera 138 may be in communication with the signal processor 106 through a signal-bearing medium represented by a dashed arrow 148. As an example, the system 100 may include both of the image projectors 102, 140; and may include both of the video cameras 104, 138. In that example, the system 100 may enable a person 128 located in the same room 126 as the object 114, or a person 130 located elsewhere, or both of them, to select which of the image projectors 102, 140 and which of the video cameras 104, 138 are operational at a given time. Further, for example, both of the video cameras 104, 138 may together be operational, and two different versions of the second image 116, 144 may be simultaneously or sequentially displayed by the video monitor 108. As another example, both of the image projectors 102, 140 may together be operational, and two different first images 110, 142 including representations of two different drawings 118 may be simultaneously or sequentially projected onto the object 114. Further, for example, a system 100 may be configured to include either the image projector 102 or the image projector 140, and the system 100 may be configured for utilization of the video cameras 104, 138 respectively by the persons 130, 128. A system 100 may, for example, be configured to include a selected one of the image projectors 102, 140. Further, for example, a system 100 may be configured to include a selected one of the video cameras 104, 138.

In further examples, the video cameras 104, 138 may be configured to facilitate zoom functionality to adjust the image field size for receiving a second image 116, 144 within a range of close-up, mid-field and distant images. In addition, the image projectors 102, 140 may be configured to facilitate zoom functionality to adjust the image field for projecting a first image 110, 142 within a range of close-up, mid-field and distant images. The zoom functionality of the image projectors 102, 140 and of the video cameras 104, 138 may, as examples, additionally or alternatively be digitally generated by the signal processor 106. Further, for examples, the image projectors 102, 140 and the video cameras 104, 138 may be configured for panning over surfaces 112 of the object 114. Additionally, the system 100 may be configured for synchronizing together the image projector 102 and the video camera 104 in panning and zooming operations, and likewise for synchronizing together the image projector 140 and the video camera 138 in panning and zooming operations. As another example, panning of the image projector 140 and the video camera 138 may depend upon movement of the person 128 who may be wearing or carrying them.

The system 100 may, for example, be configured for generating the first image 110, 142 utilizing a manually-created arbitrary drawing 118. For example, a pathologist or other person 130 may manually create an arbitrary drawing 118. An arbitrary drawing 118 may, for example, be tailored by the person 130 to external or internal tissue surfaces 112 of a particular patient 114 and to the particular surgical operation to be performed by the surgeon 128 on that patient 114. The system 100 may be configured, for example, to enable the person 130 to input the drawing 118 to the signal processor 106 so that the first image 110, 142 may be generated and provided to a surgeon or other person 128 for use in mapping a surgical operation onto a portion of the skin or exposed internal tissues 112 of a surgical patient 114. As an example, the system 100 may include an input device 150 configured for capturing the manually created drawing 118. For example, the input device may be integrated into a video monitor 151. The input device 150 may be configured to communicate with the signal processor 106 through a signal-bearing medium represented by a dashed arrow 152, and the signal processor 106 may be configured for utilizing the manually created drawing 118 to generate the first image 110, 142. The input device 150 may further be configured, for example, to display an image of the object 114 over which the pathologist or other person 130 may manually create the drawing 118 for input to the signal processor 106. For example, the input device 150 may include an image display panel 154 and may be configured for detecting, capturing and displaying the drawing 118 as manually created on the image display panel 154 by a person 130. Further, for example, the input device 150 may be aligned to function in cooperation with the image display panel 154. As examples, the input device 150 may detect stylus pressure on the image display panel 154, or may detect changes in ambient light or in pressure caused by movement of a stylus or other object such as a fingertip over the image display panel 154.

In an example, the video monitor 108 may be separate and distinct from the system 100. Further, for example, the system 100 may be configured to communicate with the video monitor 108 through signal-bearing media 124, 136. In another example, the video monitor 108 may be an integral part of the system 100. As a further example, the video monitor 108 may include an input device 156 that is integral with the video monitor 108. In that case, the input device 150 may for example be omitted. In an example, the video monitor 108 may be configured for displaying an image such as the second image 116 on an image display panel 158. Further, for example, the input device 156 may be aligned to function in cooperation with the image display panel 158 of the video monitor 108. The input device 156 may be configured, for example, for receiving manual inputs of additions, deletions, and other changes to be made in the second image 116, 144. The input device 156 may, for example, be configured for detecting and capturing changes to be made in the second image 116, 144 as manually indicated on the image display panel 158 by a person 130. As examples, the input device 156 may detect stylus pressure on the image display panel 158, or may detect changes in ambient light or in pressure caused by movement of a stylus or other object such as a fingertip over the image display panel 158. The input device 156 may be configured to communicate with the signal processor 106 through a signal-bearing medium represented by a dashed arrow 160, and the signal processor 106 may be configured for utilizing changes detected in the second image 116, 144 that is displayed on the image display panel 158, to generate the first image 110, 142.

In another example, the video monitor 108 may be configured to display the first image 110, 142, and the input device 156 may be configured, for example, for receiving manual inputs of additions, deletions, and other changes to be made in the first image 110, 142. As a further example, the video monitor 108 may be configured to display the drawing 118, and the input device 156 may be configured, for example, for receiving manual inputs of additions, deletions, and other changes to be made in the drawing 118. In another example, the system 100 may be configured for selecting a pre-determined drawing for utilization as a starting point in manual generation of the drawing 118. Further according to that example, the input device 156 may be configured to enable a person 130 to manually make additions, deletions, and other changes in the pre-determined drawing to generate the drawing 118. Also, for example, the system 100 may be configured for access to a database (not shown) for storage and retrieval of such pre-determined drawings. In further examples, the video monitor 108 may be configured for simultaneously, sequentially, or selectively displaying two or more images from among the first image 110, 142, the second image 116, 144, the drawing 118, and an image of the object 114.

The input devices 150, 156 may, as examples, be configured for receiving manual drawing inputs including additions, erasures, and other changes to be made to the first image 110, 142, second image 116, 144, or drawing 118 as may be displayed on image display panels 154, 158 of the input devices 150, 156. Such changes may include, as further examples, copying, pasting, stretching, inverting, and otherwise manipulating drawings and parts of drawings included in the first image 110, 142, second image 116, 144, or drawing 118. For example, the input devices 150, 156 may be configured for communication with the signal processor 106, wherein the signal processor 106 may have access to software suitable for causing the signal processor 106 to compute and to communicate to the input devices 150, 156, revised versions of the first image 110, 142, second image 116, 144, or drawing 118 reflecting the manual drawing inputs. As further examples, the input devices 150, 156 may themselves be configured for access to software suitable for computing and communicating to the signal processor 106, revised versions of the first image 110, 142, second image 116, 144, or drawing 118 reflecting the manual drawing inputs. Further, for example, the software may manage operation of the system 100 to select between utilization of the image projector 102 or the image projector 140, and to select between utilization of the video camera 104 or the video camera 138.

In another example, the image projector 102 may include a projector position sensor 162 capable of generating projector position information. Further, for example, the video camera 104 may include a camera position sensor 164 capable of generating camera position information. Where the system 100 includes both the projector position sensor 162 and the camera position sensor 164, the system 100 may, as an example, be configured for utilizing the position information in synchronizing together, relative to the object 114, a projector orientation and a camera orientation, regardless of how the image projector 102 or the video camera 104 are moved. Further, for example, the system 100 may be configured for utilizing the position information in generating the first image 110.

In an example, the projector position information and camera position information may be utilized by the system 100 in causing the first image 110 to appear frozen in a fixed position on a selected portion of the skin or exposed internal tissues 112 of a surgical patient 114. As another example, the position sensors 162, 164 may be omitted, but the system 100 may still have the effect of causing the first image 110 to appear so fixed on the object 114. In that example, the system 100 may be configured to calculate rapid, real-time updates of the first image 110 in response to detected changes in the second image 116. These updates may, for example, cause the first image 110 to appear to be fixed and immovable on the surface 112 of the object 114 despite movement of the object 114, or of internal parts of the object 114, or of the image projector 102 itself. The accuracy and speed of the updates may, for example, be increased by including position sensors 162, 164 in the system 100.

The image projector 102 may include, for example, a mounting device (not shown) configured for moving the image projector 102 through a range of motion suitable for operation of the system 100. As an example, such a mounting device for the image projector 102 may include (not shown) a counter-balanced suspension arm. The video camera 104 may, for example, analogously include (not shown) a mounting device, which may likewise include a counter-balanced suspension arm. As an example, the image projector 102 and the video camera 104 may both be located on the same mounting device (not shown), such as a counter-balanced suspension arm. In further examples (not shown), the projector position sensor 162 may include a magnetic or electrically-resistive sensor, or an accelerometer, or a gyroscope. For example, magnetic or electrically-resistive sensors may be located at one or more joints of a counter-balanced suspension arm on which the image projector 102 may be mounted. Further, as examples, the camera position sensor 164 may include a magnetic or electrically-resistive sensor, or an accelerometer, or a gyroscope. For example, magnetic or electrically-resistive sensors may be located at one or more joints of a counter-balanced suspension arm on which the video camera 104 may be mounted.

In another example, the image projector 140 may likewise include a projector position sensor (not shown) capable of generating projector position information. Further, for example, the video camera 138 may likewise include a camera position sensor (not shown) capable of generating camera position information.

The system 100 may be configured, for example, for utilizing changes in the projector position information or the camera position information or both types of position information, in computing a three-dimensional contour of the object 114 and for correcting the first image 110 in conformance with the contour. For example, the system 100 may be configured for access to suitable software for utilizing second images 116 of the object 114 received from the video camera 104, 138, and such position information, for computing such contours and corrected first images 110. Display by the system 100 of the accordingly-corrected first images 110 may, for example, have the function of causing the first image 110 to appear to be fixed in position on the object 114.

In another example, the image projector 102, 140 may be configured for projecting a first image 110, 142 onto a surface 112 of an object 114 in a form of laser light. As examples, the laser light may include laser light having suitable power and focal concentration for cutting or ablating the surface 112 of the object 114. For example, the system 100 so configured may be utilized for defining, through the drawing 118, a cutting or ablating operation to be carried out on a surface 112 of the skin or internal tissues of a patient 114. As further examples, the system 100 so configured may be utilized for defining, through the drawing 118, a cutting or ablating operation to be carried out on another object 114, such as a work piece to be cut or ablated. As examples, such a work piece may include wood, metal, textiles, or other materials to be cut, or a block of material to be sculpted into an arbitrary shape.

The image projectors 102, 140 of the system 100 may be implemented by any projectors suitable for the projection of light as the first image 110, 142 onto an object 114. For example, the image projectors 102, 140 may be liquid crystal display (“LCD”) projectors, or may be other types of projectors such as, for example, have been utilized in projection television applications or for projecting an image such as a slide presentation onto a reflective screen. In examples, either or both of the image projectors 102, 140 may or may not be miniaturized.

The video cameras 104, 138 of the system 100 may be implemented by any cameras suitable for receiving and transmitting the second images 116, 144. The transmission of the second images 116, 144 may be, as examples, in electronic or optical form. Further, for example, the second images 116, 144 may be transmitted in analog or digital format. In examples, either or both of the video cameras 104, 138 may or may not be miniaturized.

The signal processor 106 may be implemented by hardware, or by a combination of hardware together with either software or firmware or both software and firmware. As examples, the hardware may include one or more input modules and one or more processing modules. Examples of a processing module include a microprocessor, a general purpose processor, a digital signal processor, a logic- or decision-processing unit, a field-programmable gate array (FPGA), and an application-specific integrated circuit. If the signal processor 106 is implemented in part by software, the software may for example reside in software memory to which the signal processor 106 has access or which is integral to the signal processor 106 and which is utilized to execute the software. The software may include an ordered listing of executable instructions for implementing the signal processor 106 either in digital form such as digital circuitry or source code, or analog circuitry or an analog source such an analog electrical, sound or video signal. The software may implement algorithms configured for causing the system 100 to perform various functions such as, for example, detecting manual generation of the drawings 118, generating the first images 110, 142 from the drawings 118, correcting the first images 110, 142 for distortions due to projection of the first images 110, 142 onto a three-dimensional object 114, otherwise correcting and revising the first images 110, 142 including response to additions, deletions, and other changes input to the system 100 by the person 130, controlling the image projectors 102, 140 and the video cameras 104, 138, and distributing the first and second images 110, 116, 142, 144 within the system 100.

The video monitor 108 may be implemented by a device including an image display panel 154, 158 suitable for receiving and displaying the second images 116, 144, such as a LCD planar array, a plasma display, a cathode ray tube, or another device serving such an image display function. The input device 150, 156 may be implemented by a device including an image display panel 154, 158 also suitable for detecting the manual generation of the drawings 118. As an example, the input device 150, 156 may include a sensor array configured for detecting and mapping array coordinates of pressure applied onto the sensors, such as by a stylus or fingertip. Further, for example, the input device 150, 156 may include a sensor array configured for detecting and mapping coordinates in the array, of changes in ambient light impinging on the sensor array resulting from movement of an object such as a stylus or fingertip over sensors in the array. In further examples, the input devices 150, 156 may include a keyboard, mouse, or light pen (not shown) for generating the drawings 118. Where a system 100 includes a video monitor 108 having an input device 156, such a sensor array may for example be integral with the video monitor 108.

A system 100 may be configured with a single image projector 102, a single video camera 104, and a single signal processor 106; or may include a plurality of one or more of any or all of the same components of the system 100. Likewise, an example of a system 100 may include one or a plurality of video monitors 108, one or a plurality of input devices 150, 156, one or a plurality of digital video encoders 134, or one or a plurality of digital video decoders 135. It is understood that a system 100 may further include either one or a plurality of any of the other system components discussed herein. It is understood that all references herein to a given component of a system 100 may be applied in an analogous manner to any components of the same type or having the same function in the system 100. It is understood that all references herein to the persons 128, 130 include utilization of the system 100 by either one or a plurality of persons 128 and by either one or a plurality of persons 130. The persons 130 may be at one or a plurality of locations 132.

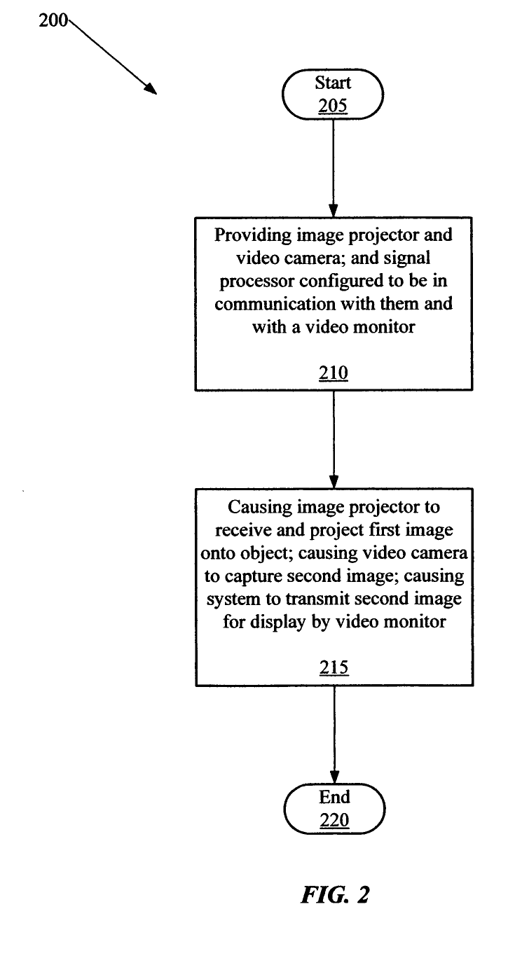

FIG. 2 is a flow chart showing an example of an implementation of a method 200. The method starts at step 205. Step 210 includes providing an image projector 102, 140 and a video camera 104, 138; and providing a signal processor 106 configured to be in communication with the image projector 102, 140, with the video camera 104, 138, and with a video monitor 108. Step 215 includes causing the image projector 102, 140 to receive and to project a first image 110, 142 onto a surface 112 of an object 114; causing the video camera 104, 138 to capture a second image 116, 144 including the first image 110, 142 as projected onto the object 114; and causing the system 100 to transmit the second image 116, 144 for display by the video monitor 108. The method may end at step 220.

In an example, step 215 may include generating a digitally encoded representation of the first image 110, 142 and a digitally encoded representation of the second image 116, 144, transmitting the digitally encoded representation of the first image 110, 142 to the image projector 102, 140, and transmitting the digitally encoded representation of the second image 116, 144 to the video monitor 108. As another example, step 215 may include displaying both of the first and second images 110, 116, 142, 144 on the video monitor 108.

The method may as another example include, at step 215, determining a difference between the drawing 118 and the second image 116, 144 and then modifying the first image 110, 142 to reduce the difference. For example, step 215 may include generating a random modification of the first image 110, 142, then re-determining the difference between the drawing 118 and the second image 116, 144, saving the first image 110, 142 if the difference is reduced, and generating another such random modification unless the difference has become less than a selected threshold.

As another example, the method may include, at step 215, action by the person 130 to visually determine a difference between the second image 116, 144 and the intended drawing (not shown) envisioned by the person 130 as represented in the drawing 118. Next in that example, the person 130 may modify the drawing 118 based on that person's envisioned drawing (not shown) while observing the resulting changes in the second image 116, 144. In that example, the person 130 may attempt to modify the drawing 118 so that the second image 116, 144 may appear the same as that person's envisioned drawing (not shown).

Further, for example, step 215 may include causing the signal processor 106 to compute a three-dimensional contour of the object 114 and to correct the first image 110, 142 in conformance with the contour. Display of the accordingly-corrected first images 110, 142 may, for example, have the function of causing the first image 110, 142 to appear to be fixed in position on the object 114.

Step 215 may, for example, include causing the video camera 138 or the image projector 140 or both, to be carried or worn by a person 128. In another example, step 215 may include utilizing the system 100 wherein the object 114 includes a surgical patient 114.

Providing the image projector 102, 140 at step 210 may, for example, include providing a projector position sensor 162 capable of generating projector position information. Providing the video camera 104, 138 at step 210 may, for example, include providing a camera position sensor 164 capable of generating camera position information. Step 215 may, as an example, include utilizing the projector position information and the camera position information in synchronizing together, relative to the object 114, an orientation of the image projector 102, 140 and an orientation of the video camera 104, 138. Further, for example, step 215 may include utilizing the projector position information and camera position information to assist in causing the first image 110, 142 to appear frozen in a fixed position on a selected portion of the skin or exposed internal tissues 112 of a surgical patient 114. As another example, step 215 may omit utilization of projector and camera position information, but may still have the effect of causing the first image 110 to appear fixed on the object 114. In that example, rapid, real-time updates of the first image 110 may be calculated in response to detected changes in the second image 116. These updates may, for example, cause the first image 110 to appear to be fixed and immovable on the surface 112 of the object 114 despite movement of the object 114, or of internal parts of the object 114, or of the image projector 102 itself. The accuracy and speed of the updates may, for example, be increased by utilizing projector and camera position information in step 215.

Further, for example, step 215 may include utilizing changes in the projector position information and in the camera position information in computing a three-dimensional contour of the object 114 and for correcting the first image 110, 142 in conformance with the contour. Additionally, step 215 may include utilizing such a three-dimensional contour of the object 114 together with the position information, in both causing the first image 110, 142 to remain in a fixed position on the object 114 and in computing a three-dimensional contour of the object 114 for correcting the first image 110, 142 in conformance with the contour.

In an additional example, step 215 may include generating the first image 110, 142 utilizing a manually-created drawing 118. Further, for example, step 210 may include providing an input device 150, 156 configured for capturing a representation of the manually created drawing 118, and including an image display panel 154, 158. Step 215 may, for example, include causing the signal processor 106 to utilize the representation of the manually created drawing 118 to generate the first image 110, 142. Step 215 may, as an example, include causing the image display panel 154, 158 to display the drawing 118, the first image 110, 142, the second image 116, 144, or an image of the object 114, or a combination including two or more of the foregoing. In another example, providing the video monitor 108 in step 210 may include providing a video monitor 108 that includes an image display panel 158 configured for displaying the first image 110, 142, the second image 116, 144, or an image of the object 114, or a combination including two or more of the foregoing; and providing the input device 156 and the video monitor 108 may include providing the input device 156 integrally with the video monitor 108 and aligned to function in cooperation with the image display panel 158. Further, for example, step 215 may include causing the first image 110, 142 to be modified in response to changes in the drawing 118; as captured by the input device 150, 156.

The system 100 may, for example, be utilized to facilitate projection of a first image 110, 142 onto an object 114 in the presence of a person 128, wherein the first image 110, 142 may be modified by a person 130. The person 130 may be present with the person 128, or may be located elsewhere, or may be one and the same person. The person 128 may, as examples, be an expert in performing a task with regard to the object 114, or may be a layman. The person 130 may, as examples, be an expert in providing advice or instructions with regard to the task to be performed, or may be a layman. As examples, the person 128 may be a surgeon, another type of medical professional, a dance instructor, a physical therapist, a mechanic, a computer technician, a worker tasked with constructing, repairing or operating an apparatus 114, or a layman with no particular expertise regarding but present together with the object 114 for performing the task. In further examples, the person 130 may be a surgeon, another type of medical professional, a dance instructor, a physical therapist, a mechanic, a computer technician, a worker tasked with constructing, repairing or operating an apparatus 114, or a layman with no particular expertise regarding the task to be performed regarding the object 114 but otherwise having input into performance of the task by the person 128. For example, the person 128 may be a surgeon, and the person 130 may be a pathologist or other medical professional called upon to provide guidance to the surgeon 128 in performing a surgical procedure on a patient 114. The method 200 may be utilized in connection with operating a suitable system 100 including an image projector 102, 140, a video camera 104, 138, and a signal processor 106 configured to be in communication with the image projector 102, 140, with the video camera 104, 138, and with a video monitor 108, of which the systems 100 disclosed are only examples. The method 200 may include additional steps and modifications of the indicated steps.

It is understood that the various examples of the system 100 illustrate analogous examples of variations of the method 200, and the entire discussion of the system 100 is accordingly deemed incorporated into the discussion of the method 200. Likewise, it is understood that the various examples of the method 200 illustrate analogous examples of variations of the system 100, and the entire discussion of the method 200 is accordingly deemed incorporated into the discussion of the system 100.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. A system, comprising:
an image projector;
a video camera; and
a signal processor configured to be in communication with the image projector, with the video camera, and with a video monitor;
wherein the image projector is configured for receiving and projecting a first image onto a surface of an object, the video camera is configured for capturing a second image including the first image as projected onto the object; and the system is configured for transmitting the second image for display by the video monitor.

2. The system of claim 1, wherein the system is configured for generating a digitally encoded representation of the first image and a digitally encoded representation of the second image, and wherein the system is configured for transmitting the digitally encoded representation of the first image to the image projector and for transmitting the digitally encoded representation of the second image to the video monitor.

3. The system of claim 1, wherein the video monitor is configured for displaying both of the first and second images.

4. The system of claim 1, wherein the first image includes a drawing, wherein the system is configured for determining a difference between the drawing and the second image, and wherein the system is configured for modifying the first image to reduce the difference.

5. The system of claim 1, wherein the signal processor is configured for computing a three-dimensional contour of the object and for correcting the first image in conformance with the contour.

6. The system of claim 1, wherein the video camera is configured for being carried or worn by a person.

7. The system of claim 1, wherein the system is configured for generating the first image utilizing a manually-created drawing.

8. The system of claim 7, including an input device configured for capturing a representation of the manually-created drawing, wherein the system is configured for utilizing the representation of the manually-created drawing to generate the first image.

9. The system of claim 8, wherein the system includes the video monitor, wherein the video monitor includes an image display panel configured for displaying the second image, and wherein the input device is integral with the video monitor.

10. The system of claim 9, wherein the system is configured for modifying the first image in response to changes in the manually-created drawing as captured by the input device.

11. The system of claim 1, wherein the image projector has a projector orientation and includes a projector position sensor capable of generating projector position information, wherein the video camera has a camera orientation and includes a camera position sensor capable of generating camera position information, and wherein the system is configured for utilizing the position information in generating the first image.

12. The system of claim 11, wherein the system is configured for utilizing changes in the position information in computing a three-dimensional contour of the object and for correcting the first image in conformance with the contour.

13. A method, comprising:
providing an image projector and a video camera; and providing a signal processor configured to be in communication with the image projector, with the video camera, and with a video monitor;
causing the image projector to receive and to project a first image onto a surface of an object;
causing the video camera to capture a second image including the first image as projected onto the object; and
causing the system to transmit the second image for display by the video monitor.

14. The method of claim 13, wherein the method includes generating a digitally encoded representation of the first image and a digitally encoded representation of the second image, and wherein the method includes transmitting the digitally encoded representation of the first image to the image projector and transmitting the digitally encoded representation of the second image to the video monitor.

15. The method of claim 13, wherein the first image includes a drawing, wherein the method includes determining a difference between the drawing and the second image, and wherein the method includes modifying the first image to reduce the difference.

16. The method of claim 13, wherein the method includes causing the signal processor to compute a three-dimensional contour of the object and to correct the first image in conformance with the contour.

17. The method of claim 13, wherein providing the image projector includes providing a projector orientation and a projector position sensor capable of generating projector position information, wherein providing the video camera includes providing a camera orientation and a camera position sensor capable of generating camera position information, and wherein the method includes utilizing the position information in generating the first image.

18. The method of claim 13, wherein the method includes generating the first image utilizing a manually-created drawing, wherein the method includes providing an input device configured for capturing a representation of the manually-created drawing, and wherein the method includes causing the signal processor to utilize the representation of the manually-created drawing to generate the first image.

19. The method of claim 18, wherein the method includes providing the video monitor, wherein the video monitor includes an image display panel configured for displaying the second image, and wherein providing the input device and the video monitor includes providing the input device integrally with the video monitor.

20. The method of claim 19, wherein the method includes modifying the first image in response to changes in the manually-created drawing as captured by the input device.
